(19) United States
(12) Patent Application Publication
(10) Pub. No.: US 2024/0346791 A1
(43) Pub. Date: Oct. 17, 2024

(54) PACKAGE BOX RECOMMENDING METHOD AND PACKAGE BOX RECOMMENDING SYSTEM

(71) Applicants: Hyundai Motor Company, Seoul (KR); Kia Corporation, Seoul (KR)

(72) Inventors: Sunjoo Moon, Suwon-si (KR); Wonseok Choi, Seongnam-si (KR); Hyejun Park, Seoul (KR)

(21) Appl. No.: 18/635,353

(22) Filed: Apr. 15, 2024

(30) Foreign Application Priority Data
Apr. 14, 2023 (KR) 10-2023-0049422
Sep. 18, 2023 (KR) 10-2023-0124073

(51) Int. Cl. G06T 19/20

(52) U.S. Cl. CPC G06T 19/20; G06T 2219/2004; G06T 2219/2016

(57) ABSTRACT

A method of recommending a final package box can include obtaining a size of each of target products, determining a packing order of the target products according to decreasing volume size, determining a location of a first target product in a three-dimensional virtual space such that a volume difference between a volume of a first packing hexahedron immediately before the current packing order and a volume of a second packing hexahedron including the first target product added in the current packing order is smallest, accordingly determining a location for each of the target products in the three-dimensional virtual space, generating a virtual final hexahedron including all of the plurality of target products, and determining the final package box among available package boxes that have width, length, and height equal to or greater than that of the virtual final hexahedron.

### CROSS-REFERENCE TO RELATED APPLICATIONS

This application claims priority to and the benefit of Korean Patent Application No. 10-2023-0049422 filed in the Korean Intellectual Property Office on Apr. 14, 2023, and Korean Patent Application No. 10-2023-0124073 filed in the Korean Intellectual Property Office on Sep. 18, 2023, the entire contents for each of which are incorporated herein by reference.

### TECHNICAL FIELD

The present disclosure relates to a package box recommending method and a package box recommending system.

### BACKGROUND

As the logistics market grows, more and more areas of work in logistics are becoming available, and there is a need to simplify work processes within the warehouse.

If a worker wants to pack multiple products in a single box, it is necessary to select the appropriate box, but currently the selection of the appropriate box is done by visual judgment for package of the products.

Poorly chosen package boxes may lead to inefficiency in repacking because the products do not fit in the box and need to be packed again, or lead to degradation of space efficiency because there is a lot of empty space in the box.

### SUMMARY

The present disclosure relates to a package box recommending method and a package box recommending system.

Some embodiments of the present disclosure can provide a package box recommending method and a package box recommending system that efficiently stack multiple products in a virtual space and recommend a package box to pack the stacked products.

An example embodiment of the present disclosure can provide a method of recommending a package box by executing, by a processor, a program that recommends a package box to pack a plurality of products, the program being stored in a memory, and the method can include: when an identification code representing each of a plurality of target products to be packed in a single package box is received from a user terminal, obtaining a size of each of the plurality of target products from size information stored in a database; determining a packing order of the plurality of target products in order of a size of a volume of the plurality of target products; determining a location of a first target product in a three-dimensional virtual space such that, in a current packing order according to the determined packing order for each of the plurality of target products, a difference between a volume of a first packing hexahedron including a first packing shape immediately before the current packing order and a volume of a second packing hexahedron including a second packing shape including the first target product added in the current packing order is smallest; determining a location for each of the plurality of target products in the three-dimensional virtual space, and generating a virtual final hexahedron including all of the plurality of target products; and determining, among the plurality of package boxes, a package box having the smallest volume among package boxes having a width, length, and height equal to or greater than that of the virtual final hexahedron as a final package box.

The determining of the packing order of the plurality of target products in order of the size of a volume of the plurality of target products may include determining the packing order between two or more target products having the same volume among the plurality of target products in order of size of weight of each of the two or more target products.

The method may further include providing a screen indicative of the packing order and a location for each of the plurality of target products.

The method may further include: determining a location of a target product corresponding to the first order in the packing order of the plurality of target products in the three-dimensional virtual space; determining a reference vertex of one of the four vertices configuring a bottom surface of the virtual final hexahedron based on the location of a target product corresponding to the first order; and determining three corners of the virtual final hexahedron that meet the reference vertex.

The method may further include determining each of the plurality of vertices configuring the first packing shape as a reference point; in which the determining of the location of the first target product may include: determining, at the reference point, one of a plurality of locations where the first packing hexahedron and a shape of the first target product meet, a first surface of the first target product is in contact with a second surface of the first packing hexahedron, and the first target product does not leave a candidate region of the virtual final hexahedron, as a first candidate location of the first target product; and measuring a volume of a first candidate packing hexahedron including both a shape of the first packing hexahedron and a shape of the first target product corresponding to the first candidate location, in which the candidate region of the virtual final hexahedron may be a region including a first side including a first corner and a second corner of the three corners, a second side including a third corner and the first corner of the three corners, and a bottom surface including the second corner and the third corner.

The determining of the location of the first target product may further include: determining a plurality of locations of the first target product rotated 90 degrees about each of three rotation axes as a plurality of second candidate locations of the first target product; and measuring a volume of the plurality of second candidate packing hexahedra including both the shape of the first packing hexahedron and the shape of the first target product corresponding to each of the plurality of second candidate locations, and the three rotation axes may be three lines that meet the reference point and are parallel to the three corners.

The method may further include determining a candidate packing hexahedron having the smallest volume among the first candidate packing hexahedron and the plurality of second candidate packing hexahedra corresponding to each of the plurality of vertices that is the reference point as the second packing hexahedron.

Another example embodiment of the present disclosure provides a system for recommending a package box, the system including: a memory for storing a program that recommends a package box to pack a plurality of products; a box recommending server for, by executing the program, determining a packing order of a plurality of target products to be packed in one box in order of a size of a volume of the plurality of target products, determining a location of a first target product in a three-dimensional virtual space such that, in a current packing order according to the determined packing order for each of the plurality of target products, a difference between a volume of a first packing hexahedron including a first packing shape immediately before the current packing order and a volume of a second packing hexahedron including a second packing shape including the first target product added in the current packing order is smallest, determining a location for each of the plurality of target products in the three-dimensional virtual space, and generating a virtual final hexahedron including all of the plurality of target products, and determining, among the plurality of package boxes, a package box having the smallest volume among package boxes having a width, length, and height equal to or greater than that of the virtual final hexahedron as a final package box; and a host server for, upon receiving an identification code representing each of the plurality of target products from a user terminal, by executing the program, calling the box recommending server.

The box recommending server may determine the packing order between two or more target products having the same volume among the plurality of target products in order of size of weight of each of the two or more target products.

The box recommending server may generate a screen indicative of the packing order and a location for each of the plurality of target products and provide the user terminal with the generated screen through the host server.

The box recommending server may determine a location of a target product corresponding to the first order in the packing order of the plurality of target products in the three-dimensional virtual space, determine a reference vertex of one of the four vertices configuring a bottom surface of the virtual final hexahedron based on the location of a target product corresponding to the first order, and determine three corners of the virtual final hexahedron that meet the reference vertex.

The box recommending server may determine each of the plurality of vertices configuring the first packing shape as a reference point, determine, at the reference point, one of a plurality of locations where the first packing hexahedron and a shape of the first target product meet, a first surface of the first target product is in contact with a second surface of the first packing hexahedron, and the first target product does not leave a candidate region of the virtual final hexahedron, as a first candidate location of the first target product, and measure a volume of a first candidate packing hexahedron including both a shape of the first packing hexahedron and a shape of the first target product corresponding to the first candidate location, and the candidate region of the virtual final hexahedron may be a region including a first side including a first corner and a second corner of the three corners, a second side including a third corner and the first corner of the three corners, and a bottom surface including the second corner and the third corner.

The box recommending server may further determine a plurality of locations of the first target product rotated 90 degrees about each of three rotation axes as a plurality of second candidate locations of the first target product, and measure a volume of the plurality of second candidate packing hexahedra including both the shape of the first packing hexahedron and the shape of the first target product corresponding to each of the plurality of second candidate locations, and the three rotation axes may be three lines that meet the reference point and are parallel to the three corners.

The box recommending server may determine a candidate packing hexahedron having the smallest volume among the first candidate packing hexahedron and the plurality of second candidate packing hexahedra corresponding to each of the plurality of vertices that is the reference point as the second packing hexahedron.

According to an embodiment of the present disclosure, it can be possible to recommend an optimized package box within a distribution center, thereby reducing unnecessary waste of materials and reducing ancillary costs.

According to an embodiment of the present disclosure, it can be possible to use a variety of package boxes in a distribution center that uses a single package box, thereby reducing costs through optimal stacking.

According to an embodiment of the present disclosure, the task of selecting a package box may be determined by a system without relying on human labor, thereby improving in terms of time and labor efficiency in selecting the package box.

### BRIEF DESCRIPTION OF THE DRAWINGS

FIG. 1 is a block diagram schematically illustrating a package box recommending system according to an example embodiment of the present disclosure.

FIG. 2 is a flowchart of a package box recommending method according to an example embodiment of the present disclosure.

FIG. 3 is a detailed flowchart of operation S300 of FIG. 2, according to an example embodiment of the present disclosure.

FIG. 4 is a detailed flowchart of operation S320 of FIG. 3, according to an example embodiment of the present disclosure.

FIG. 5 is an example diagram for illustrating a plurality of vertices of a first target product, a reference vertex of a virtual final hexahedron, and three corners of the virtual final hexahedron, according to an example embodiment of the present disclosure.

FIG. 6 is an example diagram for illustrating a first candidate location of a second target product, according to an example embodiment of the present disclosure.

FIG. 7 is an example diagram for illustrating a first candidate packing hexahedron corresponding to the first candidate location of the second target product illustrated in FIG. 6, according to an example embodiment of the present disclosure.

FIG. 8 is an example diagram for illustrating a second candidate packing hexahedron corresponding to one of a plurality of second candidate locations of the second target product, according to an example embodiment of the present disclosure.

FIG. 9 is an example diagram for illustrating an operation of rotating the second target product illustrated in FIG. 8, according to an example embodiment of the present disclosure.

FIG. 10 is an example diagram for illustrating the operation of removing an overlap error in operation S3209 of FIG. 4 according to the example embodiment of the present disclosure.

FIG. 11 is an example diagram for illustrating a first packing shape including the first target product and the second target product, according to an example embodiment of the present disclosure.

FIG. 12 is an example diagram for illustrating the locations of the first packing shape and a third target product illustrated in FIG. 11, according to an example embodiment of the present disclosure.

FIG. 13 is an example diagram for illustrating the location of each of the plurality of target products in operation S330 of FIG. 3, according to an example embodiment of the present disclosure.

FIG. 14 is an example diagram for illustrating a virtual final hexahedron including all of the plurality of target products illustrated in FIG. 13, according to an example embodiment of the present disclosure.

### DETAILED DESCRIPTION OF ILLUSTRATIVE EMBODIMENTS

Hereinafter, some example embodiments disclosed in the present specification will be described in detail with reference to the accompanying drawings, and same or similar constituent factors can be denoted by same reference numerals regardless of a reference numeral, and a repeated description thereof can be omitted. Suffixes, “module” and/or “unit” for a constituent element can be used for the description below and can be given or mixed in consideration of only easiness of the writing of the specification, and the suffix itself does not necessarily have a discriminated meaning or role. Further, in describing the example embodiments disclosed in the present disclosure, when it is determined that detailed description relating to well-known functions or configurations may make the subject matter of the example embodiments disclosed in the present disclosure unnecessarily ambiguous, the detailed description of such can be omitted. Further, the accompanying drawings are provided for helping to easily understand example embodiments disclosed in the present specification, and the technical spirit disclosed in the present specification is not necessarily limited by the accompanying drawings, and it can be appreciated that scopes of the present disclosure can include all of modifications, equivalent matters, and substitutes included in the spirit and technical scopes of the present disclosure.

Terms including an ordinary number, such as “first” and “second”, can be used for describing various constituent elements, but the constituent elements are not necessarily limited by such terms. Such terms can be used merely to discriminate one constituent element from another constituent element.

In the present application, it can be appreciated that terms “including” and “having” are intended to designate the existence of characteristics, numbers, operations, operations, constituent elements, and components described in the specification or a combination thereof, and do not exclude a possibility of the existence or addition of one or more other characteristics, numbers, operations, operations, constituent elements, and components, or a combination thereof in advance.

A program implemented as a set of instructions embodying a control algorithm used to control another configuration may be installed in a configuration for controlling another configuration under a specific control condition among configurations according to an example embodiment. The control configuration may process input data and stored data according to an installed program to generate output data. The control configuration may include a storage medium including a non-volatile memory to store a program and a memory to store data.

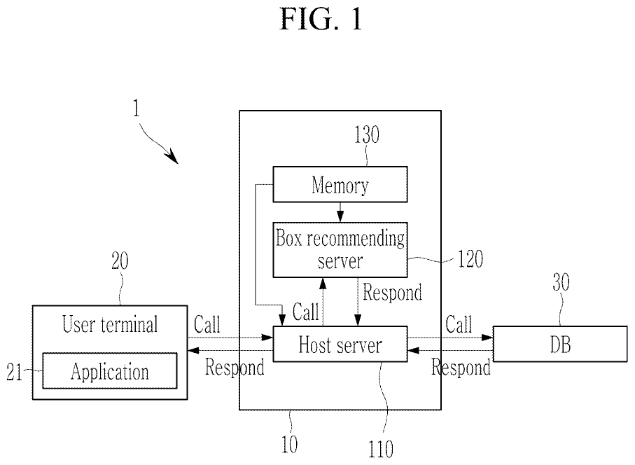

FIG. 1 is a block diagram schematically illustrating a package box recommending system according to an example embodiment of the present disclosure.

Referring to FIG. 1, a package box recommending system 1 may include a server 10, a user terminal 20, and a database 30, any combination of or all of which may be in plural or may include plural components thereof.

The server 10 can collect, process, and store various information used for determining a size of a package box, and in response to a request from the user terminal 20, such as a search and inquiry, the server 10 may collect and process relevant data among the stored data to determine one package box capable of packaging a plurality of products among the plurality of package boxes and transmit the determined box to the user terminal 20. The user may have the user terminal 200, such as a smartphone, PDA, or tablet PC. The database 30 may store information indicative of the size of each of the plurality of products and information indicative of the size of each of the plurality of package boxes. The database 30 may be an on-premise and/or cloud data storage, for example.

The user terminal 20 may be a terminal that is capable of providing the function to transmit and receive information used to provide a service for recommending a package box for packing a plurality of products (hereinafter, the “package box recommending service”) with the server 10 over a network, and that can allow an application program that processes the received information to generate information for providing the package box recommending service to be operable. For example, the user terminal 20 may be implemented as a smart phone, tablet PC, slate PC, notebook computer, personal digital assistant (PDA), or the like. The terminal applicable to the user terminal 20 is not limited to the types described above, but may be implemented as any of a variety of terminals capable of providing the functions used to provide the package box recommending service.

Referring to FIG. 1, an application 21 may be installed on the user terminal 20. The user terminal 20 may display a screen with a two- or three-dimensional modeled representation of a package box provided from the server 10 through the application 21. The application 21 may transmit information input through the user terminal 20 to the server 10. The application 21 may be a client server corresponding to a host server 110.

The application 21 may call the server 10 through the user terminal 20 to select a packing list representing a plurality of products. The packing list may include an identification code representing each of a plurality of products.

The signal received by the user terminal 20 from the server 10 may be processed as information by an application processor (AP) of the user terminal 20, and the AP of the user terminal 20 may transmit the corresponding information to the application 21 according to an example embodiment. The application 21 may perform computations based on the information received from the AP, and may cause the results of the performed computations to be displayed on the user terminal 20 or transmitted to the server 10 through the user terminal 20.

The server 10, the user terminal 20, and the database 30 may transmit and receive data through wireless and/or wired communications, and the communication methods are not limited.

Referring to FIG. 1, the server 10 may include a host server 110, a box recommending server 120, and a memory 130, any combination of or all of which may be in plural or may include plural components thereof. Upon receiving a call from the user terminal 20, the host server 110 may collect, process, and store various information used for determining a package box size, and may collect and process relevant data among the data stored in response to the request for a search, inquiry, or the like from the user terminal 20, and call the box recommending server 120 to request a package box size determination. The host server 110 may respond to a call from the user terminal 20 by generating a screen indicating a package box and a corresponding order of packing the plurality of products according to the response received from the box recommending server 120.

The operation of the host server 110 may be controlled by a host server processor corresponding to the host server 110, and the operation of the box recommending server 120 may be controlled by a box recommending server processor corresponding to the box recommending server 120.

The memory 130 may store a program for determining a package box for packing a plurality of products (hereinafter referred to as a “package box determining program”).

The host server processor may call the box recommending server 120 by executing the package box determining program stored in the memory 130 in response to the call from the host server 110. The box recommending server processor may execute the package box determining program stored in the memory 130 in response to the call from the host server 110, determine a final package box to include the plurality of target products, and respond to the host server 110 with the final package box information. Upon receiving the final package box information from the box recommending server 120, the host server processor may respond to the user terminal 20 with a screen displaying the final package box information. As described above, the server 10 may determine a service to recommend the final package box to include the plurality of target products.

The “processor” can be a configuration that processes computational operations, logical operations, determination operations, and the like to provide at least one function, which may be implemented in hardware or software or a combination of hardware and software. For example, a processor may be implemented in software, such as a task, class, subroutine, process, object, thread of execution, or program that is executed in a given area of memory, or in hardware, such as a field-programmable gate array (FPGA) or application-specific integrated circuit (ASIC), or in a combination of the software and hardware. The processor may be included on a computer-readable storage medium, or may be distributed in parts across a plurality of computers.

In the following description, the operation of the host server 110 may be the operation of the host server processor, and the operation of the box recommending server 120 may be the operation of the box recommending server processor.

The box recommending server 120 may respond to the call of the host server 110 by implementing the plurality of products in a three-dimensional virtual space according to the request of the host server 110, and determining the size of the package box by placing the plurality of products such that the size of the hexahedron including the plurality of products is the smallest through simulation.

With respect to the method of storing information indicative of the size of each of the plurality of package boxes, a user may input information indicative of the size of each of the plurality of package boxes to the user terminal 20. For example, the server 10 may transmit a question to the user terminal 20 inquiring about the size of each of the plurality of package boxes. When the user terminal 20 receives the question, the application 21 may provide a screen through the user terminal 20 to inquire about the size of each of the plurality of package boxes. When the user inputs a response to the question through the user terminal 20, the application 21 may transmit the response to the server 10 through the user terminal 20 for the size of each of the plurality of package boxes. The size of each of the plurality of package boxes may include a width, a length, and a height of the interior of the package box.

Upon receiving the response from the user terminal 20 for the size of each of the plurality of products package box, the server 10 may store the information represented by the response in the database 30.

With respect to the method of storing information indicating the size of each of the plurality of products, the server 10 may receive the corresponding information from the user terminal 20, or may scan each of the plurality of products by using a three-dimensional scanning device to determine the size of the product.

First, the operation of receiving the corresponding information from the user terminal 20 will be described. The user may input information indicative of the size of each of the plurality of products into the user terminal 20. For example, the server 10 may transit a question to the user terminal 20 inquiring about the size of each of a plurality of products. When the user terminal 20 receives the question, the application 21 may provide a screen to inquire about the size of each of the plurality of products through the user terminal 20. When the user inputs a response to the question through the user terminal 20, the application 21 may transmit the response to the server 10 through the user terminal 20 for the size of each of the plurality of products. The size of each of the plurality of products may include a width, a length, and a height of the product's appearance. Upon receiving the response from the user terminal 20 for the size of each of the plurality of package boxes, the server 10 may store the information represented by the response in the database 30.

Next, in the case of scanning each of the plurality of products by using the three-dimensional scanning device, upon receiving the release order for the plurality of products, the plurality of products to be packed may be taken from the stacking area and scanned by a conveyor and the three-dimensional scanning device prior to the packing operation. For example, the server 10 may scan the plurality of products traveling along a conveyor with the three-dimensional scanning device to determine the size of each of the plurality of products based on the detected data. The server 10 may store information indicative of the determined size in the database 30.

Hereinafter, each of the plurality of products and the plurality of package boxes are illustrated as a hexahedron for illustrative purposes, but this is for purposes of illustration only and does not limit the disclosure. The plurality of products and the plurality of package boxes may be polyhedral or other shapes.

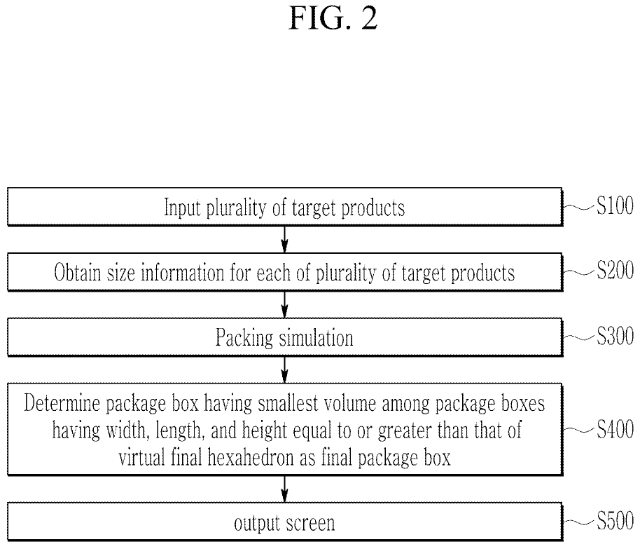

FIG. 2 is a flowchart of a package box recommending method according to an example embodiment of the present disclosure.

The user may input a plurality of target products into the user terminal 20 (operation S100).

The user may select and input into the user terminal 20 a packing list representing a plurality of target products to be packed into one of the package boxes of the product list. When the user inputs the plurality of target products to the user terminal 20, the user terminal 20 may call the server 10. The plurality of target products may represent products included in the packing list.

When the user inputs the packing list to the user terminal 20, the application 21 may transmit the packing list to the server 10 through the user terminal 20. The packing list may include an identification code representing each of a plurality of products.

The host server 110 may call the database 30 for product size information corresponding to each of the plurality of target products, and may obtain size information for each of the plurality of target products from the database 30 (operation S200).

The box recommending server 120 may obtain the size of each of the plurality of products from the size information stored in the database 30. Upon receiving the identification code of each of the plurality of products from the user terminal 20, the host server 110 may obtain the size information of each of the plurality of target products from the database 30 by calling the database 30 for the product size information corresponding to each of the plurality of target products. The host server 110 may call the box recommending server 120 by transmitting the size information of each of the plurality of target products obtained from the database 30 to the box recommending server 120. The box recommending server 120 may receive size information for each of the plurality of target products from the host server 110.

The box recommending server 120 may initiate a packing simulation to determine a package box to pack the plurality of target products based on the size information of each of the plurality of target products (operation S300).

The box recommending server 120 may generate a virtual final hexahedron including all of the plurality of target products in a three-dimensional virtual space through packing simulation.

The box recommending server 120 may extract, through the packing simulation, a plurality of package boxes having the width, length, and height equal to or greater than that of a virtual final hexahedron including all of the plurality of target products in a three-dimensional virtual space from the plurality of package boxes, and determine a package box having the smallest volume among the plurality of package boxes having the width, length, and height equal to or greater than that of the virtual final hexahedron as a final package box (operation S400).

The size information (width, length, and height) of each of the plurality of package boxes may be stored in the database 30.

The box recommending server 120 may calculate a filling rate for the final package box. The filling rate of the final package box may be a value obtained by dividing the sum of the volume of each of the plurality of target products by the volume of the final package box.

In an example embodiment, the box recommending server 120 may determine the final package box by considering a filling rate for each of the package boxes having the width, length, and height equal to or greater than that of the virtual final hexahedron.

In an example embodiment, the box recommending server 120 may also calculate a filling rate for each of a predetermined number of package boxes having the width, length, and height equal to or greater than that of the virtual final hexahedron. The predetermined number may be predetermined as initial information or determined by the user through the user terminal 20. The box recommending server 120 may determine one package box having the highest filling rate or the smallest volume among at least one package box, except for package boxes having a filling rate greater than a predetermined filling rate upper limit or smaller than a predetermined filling rate lower limit among a predetermined number of package boxes as the final package box.

In an example embodiment, the predetermined filling rate upper limit and/or the predetermined filling rate lower limit may be predetermined as initial information or determined by the user through the user terminal 20. For example, a user may set a filling rate upper limit of 90% and select no lower limit filing rate and input the selection into the user terminal 20, and the application 21 may transmit a signal to the server 10, through the user terminal 20, indicating that the filling rate upper limit is 90% and there is no filling rate lower limit.

The box recommending server 120 may respond to the host server 110 with the final package box information. The final package box information may include the size of the final package box and the filling rate of the final package box. The size of the final package box may include the width, length, and height of the final package box.

Upon receiving a response indicating the final package box from the box recommending server 120, the host server 110 may output a screen to the user terminal 20 indicating the final package box and the packing order of the plurality of target products in the final package box (operation S500).

The host server 110 may generate a screen indicating the final package box and the order of packaging the plurality of target products into the final package box and transmit the generated screen to the user terminal 20. Alternatively, the box recommending server 120 may generate a screen indicating the final package box and the order of packing the plurality of target products in the final package box and transmit the generated screen to the host server 110, and the host server 110 may transmit the received screen to the user terminal 20.

The application 21 may output, through the user terminal 20, the screen indicating the final package box and the order of packing the plurality of target products into the final package box.

The application 21 may also provide a screen on the user terminal 20 that indicates the filling rate of the final package box.

The box recommending server 120 may determine a plurality of final package boxes. The box recommending server 120 may determine the plurality of package boxes that have the smallest volume or the plurality of package boxes that take into account the filling rate among the plurality of package boxes having the width, length, and height equal to or greater than that of the virtual final hexahedron, as the plurality of final package boxes. When the box recommending server 120 determines the plurality of final package boxes,

the application 21 may output a screen through the user terminal 20 indicating the plurality of final package boxes, a filling rate corresponding to each of the plurality of final package boxes, and an order for packing the plurality of target products.

For example, when there are three final package boxes, the application 21 may display on the user terminal 20 the three final package boxes and the filling rate corresponding to each final package box. The user may select one of the three final package boxes and input the selected final package box into the user terminal 20. The application 21 may transmit, through the user terminal 20, a signal indicative of the package box selected by the user to the server 10, and the server 10 may transmit to the user terminal 20 a screen indicative of the order of packing the plurality of target products in response to the package box selected by the user. The application 21 may output a screen indicating the order of packing the plurality of target products in response to the package box selected by the user through the user terminal 20.

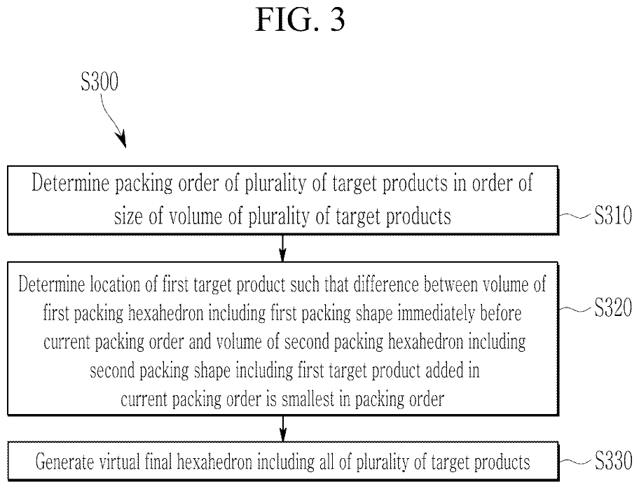

Referring now to FIGS. 3 to 14, the packing simulation in operation S300 will be described.

FIG. 3 is a detailed flowchart of operation S300 of FIG. 2.

Referring to FIG. 3, the box recommending server 120 may determine a packing order of the plurality of target products in order of the size of the volume of the plurality of target products (operation S310).

The box recommending server 120 may place the plurality of target products in order of larger volume. For example, when the plurality of target products are a first target product, a second target product, and a third target product, and the volumes of the products are larger in order of the first target product, the second target product, and the third target product, the box recommending server 120 may determine the packing order of the plurality of target products in the packing simulation to be the order of the first target product, the second target product, and the third target product.

However, the criteria for determining the packing order of the packing simulation by the box recommending server 120 is not limited to volume, but may consider the volume, weight, product characteristics, and the like, of each of the plurality of target products to determine the packing order. The product characteristic may include a characteristic of a location at which a plurality of target products that are to be placed at the top of the package box (for example, ceramics) should to be placed or a plurality of target products that are to be placed at the bottom of the package box (for example, heavy items) should be placed.

The box recommending server 120 may determine a packing order between two or more products having the same volume among the plurality of target products, in order of the size of the weight of each of the two or more products.

In determining the packing order by volume and weight, the box recommending server 120 may also determine that items that should be placed at the topmost end of the package box (for example, ceramics) during packing may have the last order for packing, and items that should be placed at the bottommost end of the package box (for example, heavy items) have the first order for packing.

The box recommending server 120 may obtain and consider volume information, weight information, product characteristics (such as whether an item should be placed at the topmost/bottommost end of the package box), and the like, for each of the plurality of target products from the database 30 in determining the packing order for the packing simulation.

The box recommending server 120 may implement the plurality of target products in a three-dimensional virtual space according to the packing order for the plurality of target products, and determine a location of the plurality of target products in the three-dimensional virtual space according to the packing order.

Hereinafter, for ease of description and by way of example, the box recommending server 120 can refer to the packing order of the plurality of target products as the order of the first target product, the second target product, and the third target product when the plurality of target products includes the first target product, the second target product, and the third target product.

In the packing order for the plurality of target products in the three-dimensional virtual space, the box recommending server 120 may determine a location of the first target product such that a difference between a volume of a first packing hexahedron including a first packing shape immediately before the current packing order and a volume of a second packing hexahedron including a second packing shape including the first target product added in the current packing order is smallest (operation S320).

The first target product is intended to describe a product that is added in the current packing order, and the disclosure is not limited thereto. The box recommending server 120 may determine the location of the first target product such that the difference between the volume of the first packing hexahedron including the first packing shape immediately before the current packing order and the volume of the second packing hexahedron including the second packing shape including the target product added in the current packing order is the smallest.

For example, it can be assumed that the packing order is first target product, the second target product, the third target product. Hereinafter, a first-1 packing hexahedron, a first-2 packing hexahedron, and a first-3 packing hexahedron are the hexahedra including the packing shape up to and including the packing shape immediately before the current packing order, and a second-1 packing hexahedron, a second-2 packing hexahedron, and a second-3 packing hexahedron are the hexahedra including the packing shape including the target product added in the current packing order.

In the above example, because there are no packed target products immediately before the first packing order corresponding to the first target product, a difference between the volume of the first-1 packing hexahedron and a volume of the second-1 packing hexahedron may be a volume of the minimum hexahedron including the shape of the first product, regardless of the location of the first target product. The box recommending server 120 may implement the target products corresponding to the first order in a three-dimensional virtual space, and arbitrarily determine the location of the first target product in the three-dimensional virtual space.

In the example described above, the first-2 packing hexahedron immediately before the second packing order corresponding to the second target product may be a minimal hexahedron including only the shape of the first target product. The box recommending server 120 may determine the location of the second target product such that a difference between a volume of the second packing hexahedron including a second-2 packing shape including the first target product and the second target product and a volume of the first-2 packing hexahedron is the smallest.

In the example described above, the first-3 packing hexahedron immediately before the third packing order corresponding to the third target product may be a minimal hexahedron including the shapes of the first target product and the second target product. The box recommending server 120 may determine the location of the third target product such that a difference between a volume of a second-3 packing hexahedron including the second packing shape including the first target product, the second target product, and the third target product and a volume of the first-3 packing hexahedron is the smallest.

This will be described in detail below.

The box recommending server 120 may sequentially implement the plurality of target products in a three-dimensional virtual space according to the packing order of the plurality of target products, and determine a location for each of the plurality of target products. Based on the packing order of the plurality of target products, the box recommending server 120 may determine a location of the target product corresponding to the current packing order among the plurality of target products such that the volume of the packing hexahedron including the shape of each of the one or more target products implemented in the three-dimensional virtual space up to the current packing order is the smallest.

As used herein, a packing hexahedron may represent a hexahedron having the smallest volume among the plurality of hexahedra including a packing shape that includes all of the shapes of the one or more target products implemented in the three-dimensional virtual space up to the current packing order according to the packing order of the plurality of target products. For example, the packing hexahedron may be a hexahedron having the smallest volume among the plurality of hexahedra having the width, length, and height equal to or greater than that of the packing shape that includes all of the shapes of the one or more target products implemented in the three-dimensional virtual space up to the current packing order.

Hereinafter, a packing shape may represent the shape of all of one or more target products implemented in the three-dimensional virtual space among the plurality of target products. For example, a packing shape may represent the shape of all of the one or more target products in a state where each of the one or more target products is placed in a correspondingly determined location.

For example, when the packing order is the first target product, the second target product, and then the third target product, and the current packing order determines the location of the third target product, the box recommending server 120 may determine the location of the third target product such that the volume of the packing hexahedron including the respective shapes of the first target product, the second target product, and the third target product is the smallest, taking into account the locations of the first target product and the second target product already implemented in the three-dimensional virtual space.

When the location of each of the plurality of target products in the three-dimensional virtual space is determined, the box recommending server 120 may generate a virtual final hexahedron including all of the plurality of target products (operation S330).

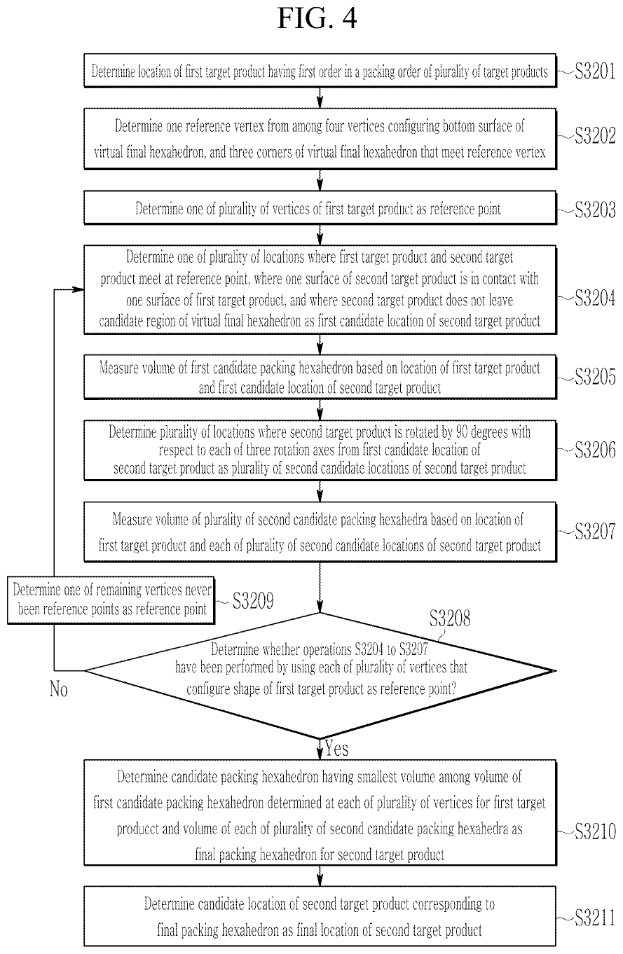

Hereinafter, operation S320 illustrated in FIG. 3 will be described with reference to FIGS. 4 to 12.

FIG. 4 is a detailed flowchart of operation S320 of FIG. 3.

Referring to FIG. 4, the box recommending server 120 may implement a target product (hereinafter, the “first target product”) corresponding to the first order in a packing order of the plurality of target products in a three-dimensional virtual space, and determine a location of the first target product in the three-dimensional virtual space (operation S3201).

The location of the first target product may be any location in the three-dimensional virtual space.

The box recommending server 120 may derive coordinates of each of the plurality of vertices configuring the shape of the first target product in response to the location of the first target product and store the derived coordinates in the database 30.

When the location of the first target product is determined, the box recommending server 120 may determine, based on the location of the first target product, one reference vertex from among the four vertices configuring the bottom surface of the virtual final hexahedron including all of the plurality of target products, and three corners of the virtual final hexahedron that meet the reference vertex (operation S3202).

The box recommending server 120 may determine one of the four vertices configuring the bottom surface of the first target product as the reference vertex of the virtual final hexahedron.

The box recommending server 120 may also determine lines extending from the three corners of the twelve corners of the first target product that meet the reference vertex in a direction away from the reference vertex as the three corners of the virtual final hexahedron. The lengths of the three corners of the virtual final hexahedron may not yet determined, and the box recommending server 120 may determine the lengths of the three corners when the locations of the plurality of target products are all determined.

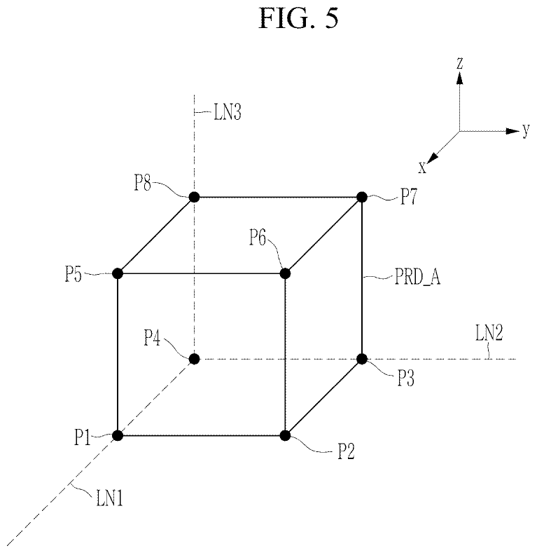

Hereinafter, the reference vertex of the virtual final hexahedron and the three corners that meet the reference vertex will be described with reference to FIG. 5.

FIG. 5 is an example diagram for illustrating a plurality of vertices of a first target product, a reference vertex of a virtual final hexahedron, and three corners of the virtual final hexahedron.

Referring to FIG. 5, the box recommending server 120 may implement a first target product PRD_A in a three-dimensional virtual space, derive coordinates of each of the plurality of vertices P1 to P8 configuring the shape of the first target product PRD_A, and determine a location of the first target product PRD_A.

The box recommending server 120 may determine one (for example, P4) of the four vertices P1 to P4 that configure the bottom surface (a plane within a line connecting points P1, P2, P3, P4, and P1 in order) of the first target product PRD_A as the reference vertex. The reference vertex may be one of the four vertices that configure the bottom surface of the virtual final hexahedron.

The box recommending server 120 may determine three lines LN1 to LN3 extending from three corners (a line connecting P1 and P4, a line connecting P3 and P4, and a line connecting P4 and P8) among the twelve corners of the first target product PRD_A that meet the reference vertex (for example, P4) in the direction away from the reference vertex (for example, P4) as three corners of the virtual final hexahedron.

The box recommending server 120 may determine that a first surface bounded by the line LN1 and the line LN2 and including the line LN1 and the line LN2 is the bottom surface of the virtual final hexahedron. The box recommending server 120 may determine a second surface bounded by the line LN2 and the line LN3 and including the line LN2 and the line LN3 as a first side of the virtual final hexahedron. The box recommending server 120 may determine a third surface bounded by the line LN1 and the line LN3 and including the line LN1 and the line LN3 as a second side adjacent to the first side of the virtual final hexahedron.

Hereafter, the infinite region consisting of the first side, the second side, and the bottom surface can be referred to as the “candidate region of the virtual final hexahedron”. The candidate region of the virtual final hexahedron may be a region including the bottom surface including the first and second lines (for example, LN1 and LN2 in FIG. 5) of the three lines LN1 to LN3, the first side including the second and third lines (for example, LN2 and LN3 in FIG. 5), and the second side including the first and third lines (for example, LN1 and LN3 in FIG. 5).

The box recommending server 120 may determine one of the plurality of vertices configuring the shape of the first target product as a reference point (operation S3203).

Referring to FIG. 5, the box recommending server 120 may determine one (for example, P2) of the plurality of vertices P1 to P8 of the first target product PRD_A as a reference point.

Referring again to FIG. 4, the box recommending server 120 may determine one of a plurality of locations where the first target product and the second target product meet at the reference point, where one surface of the second target product is in contact with one surface of the first target product, and where the second target product does not leave the candidate region of the virtual final hexahedron as a first candidate location for the second target product (operation S3204).

The box recommending server 120 may derive the coordinates of each of the plurality of vertices configuring the shape of the second target product in response to the first candidate location of the second target product.

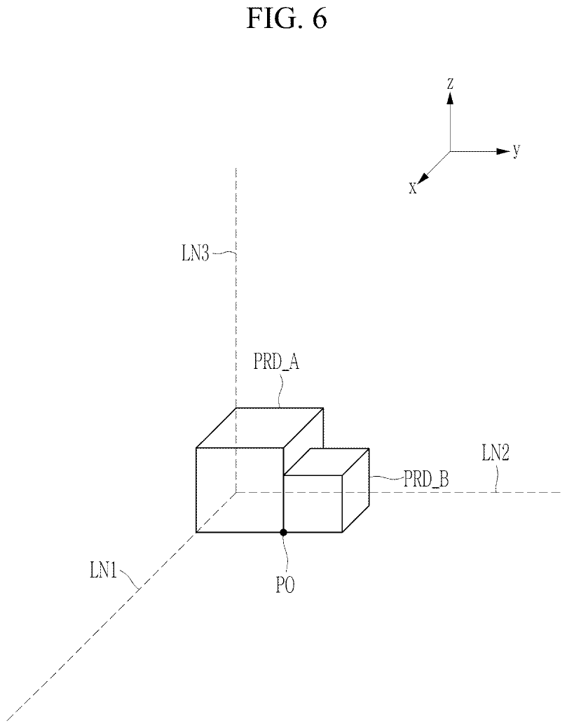

FIG. 6 is an example diagram for illustrating the first candidate location of the second target product.

Referring to FIG. 6, the box recommending server 120 may determine one point Po of the plurality of vertices of the first target product PRD_A as a reference point. In the first candidate location of the second target product PRD_B illustrated in FIG. 6, the second target product PRD_B meets the first target product PRD_A at the reference point Po, and the surface of the second target product PRD_B in the negative y-axis direction is in contact with the surface of the first target product PRD_A in the positive y-axis direction. Also, the second target product PRD_B does not leave the candidate region of the virtual final hexahedron corresponding to the three lines LN1 to LN3.

Referring again to FIG. 4, the box recommending server 120 may measure the volume of a first candidate packing hexahedron including the packing shape in which the first target product and the second target product are packed based on the location of the first target product determined in operation S3201 and the first candidate location of the second target product determined in operation S3204 (operation S3205).

The packing hexahedron in each of the packing orders of the plurality of target products may be one of a plurality of candidate packing hexahedra to be determined below, in response to each packing order. In other words, a candidate packing hexahedron may represent the hexahedron having the smallest volume among the plurality of hexahedra that includes all of the packing shape of the plurality of target products in the packing order immediately before the current packing order and the shape at the candidate location of the target product added in the current packing order.

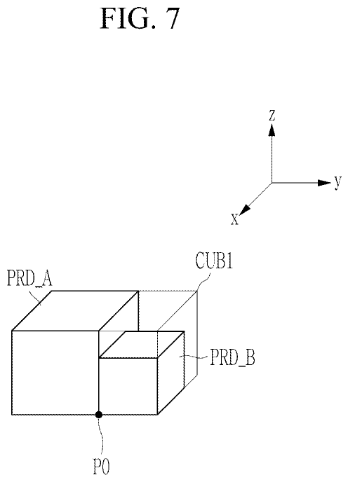

FIG. 7 is an example diagram for illustrating the first candidate packing hexahedron corresponding to the first candidate location of the second target product illustrated in FIG. 6.

Referring to FIG. 7, the first candidate packing hexahedron CUB1 may include both the shape of the first target product PRD_A and the shape of the second target product PRD_B located at the first candidate location.

Referring again to FIG. 4, the box recommending server 120 may determine a plurality of locations where the second target product is rotated by 90 degrees with respect to each of the three rotation axes from the first candidate location of the second target product as a plurality of second candidate locations of the second target product (operation S3206).

Corresponding to each of the plurality of second candidate locations of the second target product, the box recommending server 120 may derive coordinates of each of the plurality of vertices configuring the shape of the second target product.

The three rotation axes may be three lines that meet the reference point and are parallel to the three lines (for example, LN1 to LN3 in FIG. 6) of the virtual final hexahedron.

The direction in which the box recommending server 120 rotates the second target product may be predetermined with one of a clockwise direction and a counterclockwise direction relative to each of the three rotation axes. For simplicity of description, it can be assumed that the direction of rotation of the second target product is clockwise, for example.

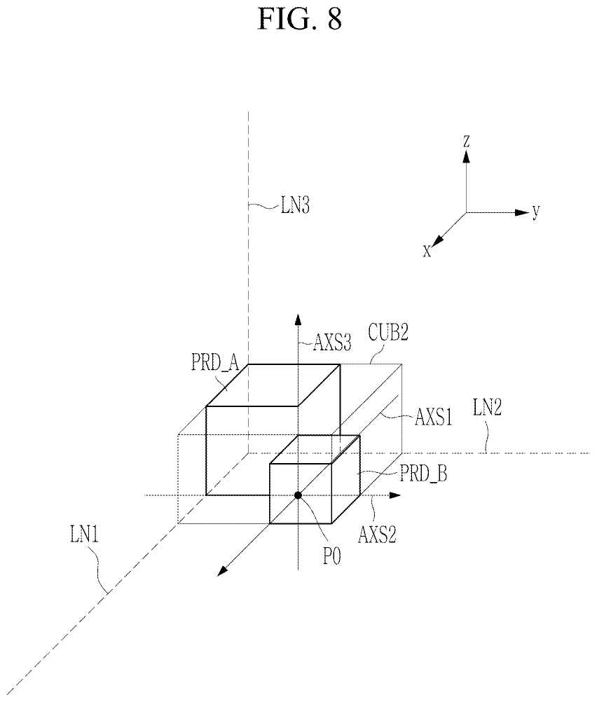

FIG. 8 is an example diagram for illustrating a second candidate packing hexahedron corresponding to one of a plurality of second candidate locations of the second target product.

Referring to FIG. 8, the box recommending server 120 may determine three lines AXS1 to AXS3 that meet the reference point Po and are parallel to the three lines LN1 to LN3 of the virtual final hexahedron as three rotation axes.

The box recommending server 120 may determine a location where the second target product is rotated 90 degrees with respect to each of the three rotation axes AXS1 to AXS3 (for example, AXS3) from the first candidate location of the second target product illustrated in FIG. 7 as one of the plurality of second candidate locations of the second target product.

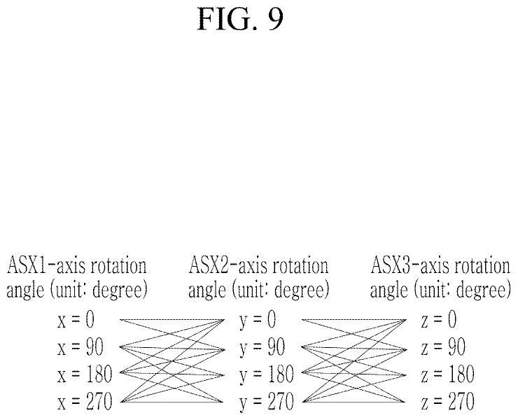

FIG. 9 is an example diagram for illustrating an operation of rotating the second target product illustrated in FIG. 8.

Referring to FIG. 9, in operation S3206, the box recommending server 120 may determine a plurality of second candidate locations to cause the placement in operation S3204 to correspond to each of the combinations of the rotations 90 degrees with respect to each of the three rotation axes AXS1 to AXS3.

Referring to FIGS. 8 and 9, the box recommending server 120 may rotate the second target product from the first candidate location illustrated in FIG. 7 by one of 0 degrees, 90 degrees, 180 degrees, and 270 degrees in the clockwise direction about the rotation axis AXS1, rotate the second target product by one of 0 degrees, 90 degrees, 180 degrees, and 270 degrees in the clockwise direction about the rotation axis AXS2, and rotate the second target product by one of 0 degrees, 90 degrees, 180 degrees, and 270 degrees in the clockwise direction about the rotation axis AXS3 to generate 64 locations (i.e., 4*4*4=64 locations).

The box recommending server 120 may determine the remaining locations left after removing a first candidate location for the second target product (for example, a location corresponding to a rotation angle of 90 degrees for each of the three rotation axes AXS1 to AXS3 from the first candidate location) and the locations after removing rotation errors, from the locations generated by rotating the second target product as a plurality of second candidate locations. The box recommending server 120 may remove the rotation error in a predetermined order of determination for the generated locations.

The rotation error may include a first rotation error indicating a location that overlaps with a previously generated location among the locations that the box recommending server 120 rotates the second target product to generate sequentially in the predetermined order of determination, and a second rotation error indicating that the second target product corresponding to each of the generated locations leaves the candidate region of the virtual final hexahedron.

The box recommending server 120 may derive the coordinates of each of the plurality of vertices configuring the shape of the second target product in response to each of the locations sequentially generated by rotating the second target product.

The box recommending server 120 may determine that the location generated in the current order is the first rotation error when the coordinates of a plurality of vertices corresponding to the location generated in the current order in a predetermined order of determination that removes the rotation error overlap the coordinates of the plurality of vertices corresponding to the previously generated location. The box recommending server 120 may determine that the location generated in the current order is a second rotation error when at least one of the plurality of vertex coordinates corresponding to the location generated in the current order in the predetermined order of determination that removes the rotation error leaves the candidate region of the virtual final hexahedron.

The box recommending server 120 may determine the remaining locations left after removing the first candidate location of the second target product, the location corresponding to the first rotation error, and the location corresponding to the second rotation error from the generated locations as the plurality of second candidate locations.

Referring again to FIG. 4, the box recommending server 120 may measure the volume of the plurality of second candidate packing hexahedra including the packing shape in which the first target product and the second target product are packed based on the location of the first target product determined in operation S3201 and each of the plurality of second candidate locations of the second target product determined in operation S3206 (operation S3207).

Referring to FIG. 8, the second candidate packing hexahedron CUB2 corresponding to the one second candidate location illustrated in FIG. 8 among the plurality of second candidate packing hexahedra may include both the shape of the first target product PRD_A and the shape of the second target product PRD_B located at the one second candidate location illustrated in FIG. 8.

Referring again to FIG. 4, the box recommending server 120 may determine whether operations S3204 to S3207 have been performed using each of the plurality of vertices (for example, P1 to P8 in FIG. 5) that configure the shape of the first target product (for example, PRD_A in FIG. 5) as a reference point (operation S3208).

When it is determined that operations S3204 to S3207 have not been performed using each of the plurality of vertices (for example, P1 to P8 in FIG. 5) configuring the shape of the first target product (for example, PRD_A in FIG. 5) as the reference point in operation S3208, the box recommending server 120 may determine one of the remaining vertices (for example, P1, and P3 to P8 in FIG. 5) that have never been the reference points among the plurality of vertices (for example, P1 to P8 in FIG. 5) that configure the shape of the first target product (for example, PRD_A in FIG. 5) as a reference point (operation S3209).

Operation S3209 may be followed by operation S3204.

In other words, the box recommending server 120 may repeat operations S3204 to S3209 until operations S3204 to S3207 are performed with all of the plurality of vertices (for example, P1 to P8 in FIG. 5) that configure the shape of the first target product (for example, PRD_A in FIG. 5) as the reference point.

When it is determined that operations S3204 to S3207 have been performed using each of the plurality of vertices (for example, P1 to P8 in FIG. 5) configuring the shape of the first target product (for example, PRD_A in FIG. 5) as the reference point in operation S3208, the box recommending server 120 determines a candidate packing hexahedron having the smallest volume among the volume of the first candidate packing hexahedron determined at each of the plurality of vertices (for example, P1 to P8 in FIG. 5) and the volume of each of the plurality of second candidate packing hexahedra as the final packing hexahedron for the second target product (operation S3210).

Because the final packing hexahedron for the second target product is the hexahedron with the smallest volume among the candidate packing hexahedra, the candidate packing hexahedron that has the smallest volume difference between the volume difference between the packing hexahedron including only the first target product that has the packing shape immediately before the current order in the packing order of the plurality of target products and each of the candidate packing hexahedra of the second target product may be the final packing hexahedron with the smallest volume among the candidate packing hexahedra.

The volume of each of the candidate packing hexahedra may have the value obtained by adding the volume of the packing hexahedron including the packing shape immediately before the current packing order to the volume added due to the location of the target product added in the current packing order among the plurality of target products. Herein, the volume added due to the location of the target product added in the current packing order among the plurality of target products is the difference between the volume of the packing hexahedron including the packing shape immediately before the current packing order and the volume of the packing hexahedron including the packing shape including the target product added in the current packing order.

Thus, the box recommending server 120 may determine that the final packing hexahedron with the smallest volume among the candidate packing hexahedra is the packing hexahedron with the smallest difference between the difference between the volume of the packing hexahedron including the packing shape immediately before the current packing order and the volume of the packing hexahedron including the packing shape including the target product added in the current packing order.

In the examples of FIGS. 7 and 8, it may be determined that the volume of the second candidate packing hexahedron CUB2 between the first candidate packing hexahedron CUB1 illustrated in FIG. 7 and the second candidate packing hexahedron CUB2 illustrated in FIG. 8 is larger than the volume of the first candidate packing hexahedron CUB1.

In determining the final packing hexahedron of the second target product, the box recommending server 120 may determine whether the final packing hexahedron of the second target product has the smallest volume based on the remaining volumes with overlap error removed among the volume of the first candidate packing hexahedron corresponding to each of the plurality of vertices (for example, P1 to P8 in FIG. 5) configuring the shape of the first target product (for example, PRD_A in FIG. 5) and the volume of each of the plurality of second candidate packing hexahedra.

The overlap error may be an error where the shape of the second target product overlaps the shape of the first target product.

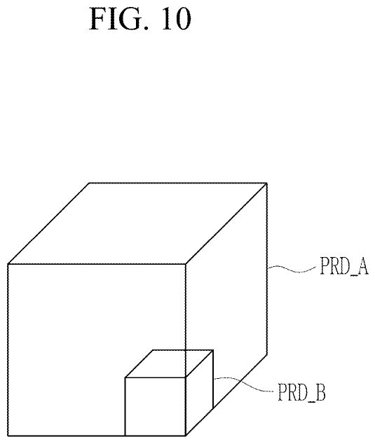

FIG. 10 is an example diagram for illustrating the operation of removing an overlap error in operation S3209 of FIG. 4 according to the example embodiment.

Referring to FIG. 10, when the shape of the second target product PRD_B is included in the shape of the first target product PRD_A, the volume of the candidate packing hexahedron including the shape of each of the first target product PRD_A and the second target product PRD_B may be equal to the volume of the first target product PRD_A. The box recommending server 120 may remove the overlap error based on the volume of the candidate packing hexahedron. For example, when the volume of the candidate packing hexahedron including the shape of each of the first target product PRD_A and the second target product PRD_B falls within a predetermined error range based on the volume of the first target product PRD_A, the box recommending server 120 may determine that the candidate packing hexahedron has an overlap error and remove the overlap error from the final candidate packing hexahedron.

The box recommending server 120 may determine the candidate packing hexahedron having the smallest volume of the volume of each of the plurality of second candidate packing hexahedra with the overlap error removed as the final packing hexahedron for the second target product.

Although it has been described in the present specification that the rotation error is removed in determining the plurality of second candidate locations in operation S3206 illustrated in FIG. 4 and the overlap error is removed in determining the final packing hexahedron in operation S3210 illustrated in FIG. 4, this is for convenience of description only and does not limit the disclosure. The box recommending server 120 may remove each of the rotation error and the overlap error at any of operations S3204 to S3210.

In some example embodiments, the box recommending server 120 may determine all of the locations generated by rotating the second target product in operation S3206 illustrated in FIG. 4 as the plurality of second candidate locations, and remove the rotation error in operation S3210 illustrated in FIG. 4. In some example embodiments, the box recommending server 120 may also remove the overlap error in determining the plurality of second candidate locations from the locations generated by rotating the second target product in operation S3206 illustrated in FIG. 4.

The box recommending server 120 may determine that a candidate packing hexahedron in which the second target product PRD_B overlaps the first target product PRD_A, or is located at a candidate location leaving the candidate region of the virtual final hexahedron is the overlap error and remove the overlap error from the final candidate packing hexahedron.

The box recommending server 120 may sort the volume of the first candidate packing hexahedron and the volume of each of the plurality of second candidate packing hexahedra in order of smallest volume, remove the overlap error from among the first candidate packing hexahedron and the plurality of second candidate packing hexahedra, and determine the candidate packing hexahedron with the smallest volume among the remaining candidate packing hexahedra with the overlap error removed as the final packing hexahedron for the second target product.

When there are two or more candidate packing hexahedra with the smallest volume among the candidate packing hexahedra, one candidate packing hexahedron may be determined as the final packing hexahedron based on a predetermined priority among the two or more candidate packing hexahedra. The predetermined priority is a matter that can be preferentially considered in selecting the final packing hexahedron by the box recommending server 120, and may be set by a user. For example, in the predetermined priority, the priority may be higher as the location of a center point of the candidate packing hexahedron representing the volume center of the target product added in the current packing order is closer to the reference vertex determined in operation S3202 of FIG. 4.

The box recommending server 120 may determine the candidate location of the second target product corresponding to the final packing hexahedron determined in operation S3210 of FIG. 4 between the first candidate location determined in operation S3204 of FIG. 4 and the plurality of second candidate locations determined in operation S3206 of FIG. 4 as a final location of the second target product (operation S3211).

Corresponding to the location of the second target product, the box recommending server 120 may derive the coordinates of each of the plurality of vertices configuring the first packing shape including the first target product and the second target product and store the derived coordinates in the database 30.

The description of the first target product and the second target product in FIGS. 4 to 10 may be equally applied to any packing order for a plurality of target products in which the first target product is the first packing shape in the packing order for the plurality of target products immediately before the current packing order, and the second target product is a target product added in the current packing order.

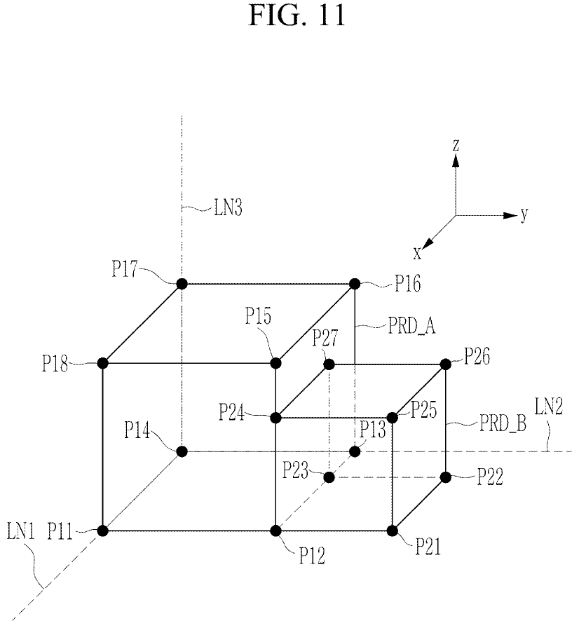

FIG. 11 is an example diagram for illustrating the first packing shape including the first target product and the second target product.

Referring to FIG. 11, upon determining the respective locations of the first target product PRD_A and the second target product PRD_B, the box recommending server 120 may implement a first packing shape including the first target product PRD_A and the second target product PRD_B based on a plurality of vertices P11 to P18 configuring the shape of the first target product PRD_A and a plurality of vertices P12, and P21 to P27 configuring the shape of the second target product PRD_B.

The plurality of vertices configuring the first packing shape may include all of the vertices P11 to P18 of the first target product PRD_A and the vertices P12, and P21 to P27 of the second target product PRD_B, and may include only one vertex at which the vertices P11 to P18 of the first target product PRD_A overlap the vertices P12, and P21 to P27 of the second target product PRD_B (the vertices P11 to P18 of the first target product PRD_A).

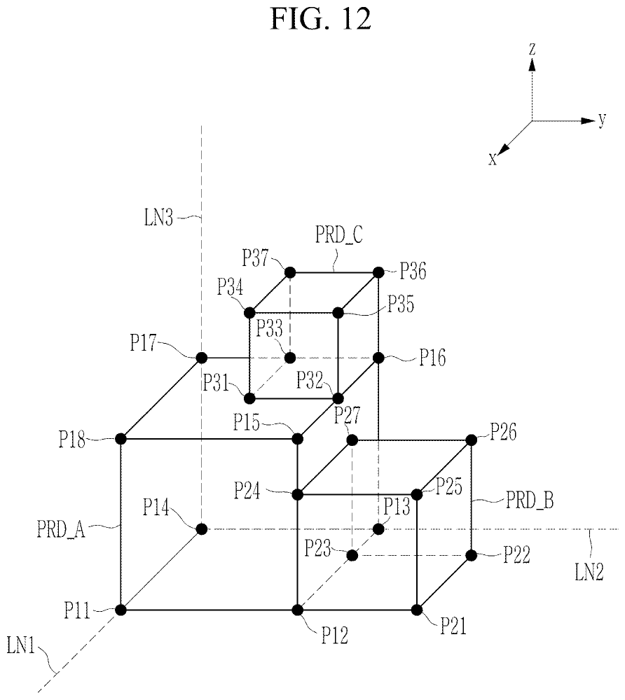

FIG. 12 is an example diagram for illustrating the locations of the first packing shape illustrated in FIG. 11 and a third target product.

Referring to FIG. 12, the box recommending server 120 may determine that at a reference point P16 of one of the plurality of vertices P11 to P18, and P21 to P27 of the first packing shape including the first target product PRD_A and the second target product PRD_B, the location illustrated such that the first packing shape meets the third target product PRD_C, and the surface of the first packing shape PRD_A and PRD_B in the positive z-axis direction is in contact with the surface of the third target product PRD_C in the negative z-axis direction is the location of the third target product PRD_C.

The box recommending server 120 may derive and store in the database 30 the coordinates of each of the plurality of vertices P11 to P18, P21 to P27, and P31 to P37 configuring the first packing shape PRD_A and PRD_B, and the second packing shape PRD_A, PRD_B, and PRD_C including the third target product PRD_C, corresponding to the location of the third target product PRD_C.

When the box recommending server 120 has determined the location of each of the plurality of target products in the three-dimensional virtual space, in operation S330 of FIG. 3, the box recommending server 120 may generate a virtual final hexahedron that includes all of the plurality of target products.

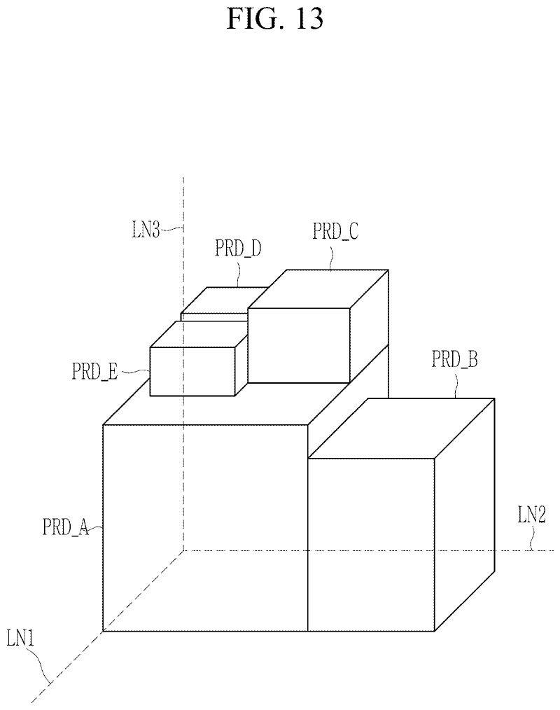

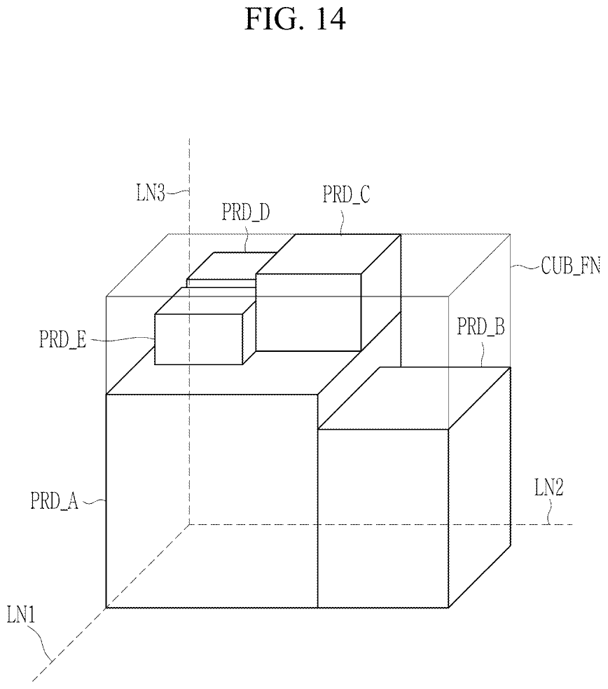

Hereinafter, operation S330 of FIG. 3 will be described with reference to FIGS. 13 and 14.

FIG. 13 is an example diagram for illustrating the location of each of the plurality of target products in operation S330 of FIG. 3.

FIG. 14 is an example diagram for illustrating a virtual final hexahedron including all of the plurality of target products illustrated in FIG. 13.

Referring to FIG. 13, it is assumed that the plurality of target products includes a first target product PRD_A, a second target product PRD_B, a third target product PRD_C, a fourth target product PRD_D, and a fifth target product PRD_E. When the packing order of the plurality of target products PRD_A, PRD_B, PRD_C, PRD_D, and PRD_E is in the following order: the first target product PRD_A, the second target product PRD_B, the third target product PRD_C, the fourth target product PRD_D, and the fifth target product PRD_E, each location may be determined in order of the first target product PRD_A, the second target product PRD_B, the third target product PRD_C, the fourth target product PRD_D, and the fifth target product PRD_E, this is similar to FIG. 13.

Referring to FIG. 14, the box recommending server 120 may determine a virtual final hexahedron CUB_FN that includes all of the plurality of target products PRD_A, PRD_B, PRD_C, PRD_D, and PRD_E.

The box recommending server 120 may derive the coordinates of each of the plurality of vertices that configures the shape of the virtual final hexahedron CUB_FN and store the derived coordinates in the database 30.

The box recommending server 120 may determine the smallest volume hexahedron among the hexahedra including all of the plurality of target products as the virtual final hexahedron CUB_FN. The box recommending server 120 may determine the lengths of the three lines LN1 to LN3 of the virtual final hexahedron as lengths corresponding to the plurality of vertices that configure the shape of the virtual final hexahedron CUB_FN.

After the virtual final hexahedron CUB_FN is generated, in operation S400 of FIG. 2, the box recommending server 120 may determine the package box having the smallest volume among the boxes having the width, length, and height equal to or greater than that of the virtual final hexahedron as the final package box. The location of each of the plurality of target products PRD_A, PRD_B, PRD_C, PRD_D, and PRD_E corresponding to the virtual final hexahedron CUB_FN may be located within the final package box.

The host server 110 or the box recommending server 120 may generate a screen indicating the shape of the final package box and the location of the plurality of target products (for example, PRD_A, PRD_B, PRD_C, PRD_D, PRD_E in FIG. 14) located within the final package box. The host server 110 or the box recommending server 120 may also generate a screen indicating the packing order of the plurality of target products (for example, PRD_A, PRD_B, PRD_C, PRD_D, PRD_E in FIG. 14).

The host server 110 or the box recommending server 120 may generate a screen indicating size information (width, length, and height) and/or a name of the final package box (for example, Post Office No. 5 box) among the plurality of package boxes stored in the database 30.

The screen generated by the host server 110 or the box recommending server 120 may be transmitted by the host server 110 to the user terminal 20, and the user terminal 20 may provide the received screen to the user. The user may view a screen indicating the shape of the final package box, the location of the plurality of target products, the packing order of the plurality of target products, and the like, through the user terminal 20.

While the present disclosure has been described in connection with what is presently considered to be practical example embodiments, it can be understood that the present disclosure is not necessarily limited to the disclosed example embodiments.

What is claimed is:

1. A method of recommending a package box by executing, by a processor, a program that recommends a package box to pack a plurality of products, the program being stored in a memory, the method comprising:
in response to an identification code representing each of a plurality of target products to be packed in a single package box being received from a user terminal, obtaining a target product size of each of the plurality of target products from target product size information stored in a database;
determining a packing order of the plurality of target products in order of decreasing volume of the plurality of target products;
determining a first target product location of a first target product of the plurality of target products in a three-dimensional virtual space such that, in a current packing order according to the determined packing order for each of the plurality of target products, so that a volume difference between a first packing hexahedron volume of a first packing hexahedron including a first packing shape immediately before the current packing order and a second packing hexahedron volume of a second packing hexahedron including a second packing shape including the first target product added in the current packing order becomes smallest;
determining a packing location for each of the plurality of target products in the three-dimensional virtual space, to generate a virtual final hexahedron including all of the plurality of target products; and
determining a final package box among a plurality of package boxes, wherein the final package box has a smallest volume among a subset of the plurality of package boxes having a width, a length, and a height equal to or greater than that of the virtual final hexahedron.

2. The method of claim 1, wherein determining the packing order comprises determining the packing order between two or more target products having a same volume among the plurality of target products in order of decreasing weight of each of the two or more target products.

3. The method of claim 1, further comprising providing a screen indicative of the determined packing order and the packing location for each of the plurality of target products.

4. The method of claim 1, further comprising:
determining a first packing location for the first target product corresponding to a first order in the determined packing order of the plurality of target products in the three-dimensional virtual space;
determining a reference vertex of one of four vertices configuring a bottom surface of the virtual final hexahedron based on the first packing location; and
determining three reference lines of the virtual final hexahedron that meet at the reference vertex.

5. The method of claim 4, further comprising determining each of the four vertices of the first packing location as configuring the first packing shape as a reference point, wherein the determining of the first packing location of the first target product further comprises:
determining, at the reference point, one of a plurality of locations where the first packing hexahedron and a shape of the first target product meet, a first surface of the first target product is virtually in contact with a second surface of the first packing hexahedron, and the first target product does not leave a candidate region of the virtual final hexahedron, as a first candidate location of the first target product; and
measuring a volume of a first candidate packing hexahedron including both a shape of the first packing hexahedron and a shape of the first target product corresponding to the first candidate location, wherein the candidate region of the virtual final hexahedron is a region including a first side including a first reference line and a second reference line of the three reference lines, a second side including a third reference line and the first reference line of the three reference lines, and a bottom surface including the second reference line and the third reference line.

6. The method of claim 5, wherein determining the location of the first target product further comprises:
determining a plurality of locations of the first target product rotated 90 degrees about each of three rotation axes as a plurality of second candidate locations of the first target product; and
measuring a volume of the plurality of second candidate packing hexahedra including both the shape of the first packing hexahedron and the shape of the first target product corresponding to each of the plurality of second candidate locations, wherein the three rotation axes meet at the reference point and are parallel to the three reference lines.

7. The method of claim 6, further comprising determining a candidate packing hexahedron having the smallest volume among the first candidate packing hexahedron and the plurality of second candidate packing hexahedra corresponding to each of the four vertices that is the reference point as the second packing hexahedron.

8. A system comprising:
a non-transitory memory storing a program that recommends a final package box, among a plurality of package boxes, to pack a plurality of products;
a box recommending server, by executing the program, enabled to:
determine a packing order of a plurality of target products to be packed in one box in order of a volume size of the plurality of target products;
determine a location of a first target product in a three-dimensional virtual space such that, in a current packing order according to the determined packing order for each of the plurality of target products so that a volume difference between a first packing hexahedron volume of a first packing hexahedron including a first packing shape immediately before the current packing order and a second packing hexahedron volume of a second packing hexahedron including a second packing shape becomes smallest, wherein the second packing shape includes the first target product added in the current packing order;
determine a packing location for each of the plurality of target products in the three-dimensional virtual space, and generating a virtual final hexahedron including all of the plurality of target products; and
determining, among the plurality of package boxes, the final package box, wherein the final package box has a smallest volume among a subset of the plurality of package boxes having a width, a length, and a height equal to or greater than that of the virtual final hexahedron; and
a host server configured to call the box recommending server upon receiving an identification code representing each of the plurality of target products from a user terminal.

9. The system of claim 8, wherein the box recommending server, by executing the program, is further enabled to determine the packing order between two or more target products having a same volume among the plurality of target products in order of weight size of each of the two or more target products.

10. The system of claim 8, wherein the box recommending server, by executing the program, is further enabled to:
generate a screen indicative of the packing order and the packing location for each of the plurality of target products; and
provide the user terminal with the generated screen through the host server.

11. The system of claim 8, wherein the box recommending server, by executing the program, is further enabled to:
determine a first location of a first target product corresponding to a first order in the packing order of the plurality of target products in the three-dimensional virtual space;
determine a reference vertex of one of four vertices configuring a bottom surface of the virtual final hexahedron based on the first location of a first target product corresponding to the first order; and
determine three reference lines of the virtual final hexahedron that meet at the reference vertex.

12. The system of claim 11, wherein the box recommending server, by executing the program, is further enabled to:
determine each of the four vertices configuring the first packing shape as a reference point;
determine, at the reference point, one of a plurality of locations where the first packing hexahedron and a shape of the first target product meet, a first surface of the first target product is virtually in contact with a second surface of the first packing hexahedron, and the first target product does not leave a candidate region of the virtual final hexahedron, as a first candidate location of the first target product, and
measure a first candidate packing hexahedron volume of a first candidate packing hexahedron including both a shape of the first packing hexahedron and a shape of the first target product corresponding to the first candidate location, wherein the candidate region of the virtual final hexahedron is a region including a first side including a first reference line and a second reference line of the three reference lines, a second side including a third reference line and the first reference line of the three reference lines, and a bottom surface including the second reference line and the third reference line.

13. The system of claim 12, wherein the box recommending server, by executing the program, is further enabled to:
determine a plurality of locations of the first target product rotated 90 degrees about each of three rotation axes as a plurality of second candidate locations of the first target product; and
measure a volume of the plurality of second candidate packing hexahedra including both the shape of the first packing hexahedron and the shape of the first target product corresponding to each of the plurality of second candidate locations, wherein the three rotation axes are three lines that meet at the reference point and are parallel to the three reference lines.

14. The system of claim 13, wherein the box recommending server, by executing the program, is further enabled to determine a candidate packing hexahedron having the smallest volume among the first candidate packing hexahedron and the plurality of second candidate packing hexahedra corresponding to each of a plurality of vertices that is the reference point as the second packing hexahedron.

15. A method comprising:
obtaining a target product size of each of a set of target products;
determining a packing order of the set of target products in order of decreasing volume of the set of target products;
through simulation, placing a first target product, for a first iteration of the determined packing order, in a first target product location in a three-dimensional virtual space;
through simulation, for a current iteration of the determined packing order after the first iteration, determining a current target product location of a current target product of the set of target products in the three-dimensional virtual space such that a volume difference is smallest, wherein the volume difference is between
a previous packing hexahedron volume of a previous packing hexahedron including a previous packing shape for a previous iteration of the determined packing order, and
a current packing hexahedron volume of a current packing hexahedron including a current packing shape, wherein the current packing shape includes the current target product added to the previous packing shape;
through simulation, sequentially performing the determining of the current target product location for each iteration of the determined packing order after the first iteration until all of the set of target products have been virtually packed in the three-dimensional virtual space for the determined packing order, to generate a virtual final hexahedron including all of the set of target products;
determining a physical final package box among a plurality of available physical package boxes, wherein the physical final package box has a smallest volume among a subset of the plurality of available physical package boxes having a width, a length, and a height equal to or greater than that of the virtual final hexahedron; and
packing the a set of target products in the physical final package box.

16. The method of claim 15, wherein the determining of the packing order includes determining the packing order between two or more target products having a same volume among the set of target products in order of decreasing weight.

17. The method of claim 15, further comprising providing a screen indicative of the determined packing order and the current target product location for each of the set of target products.

18. The method of claim 15, further comprising:
determining a reference vertex of one of four vertices configuring a bottom surface of the virtual final hexahedron based on the first target product location; and
determining three reference lines of the virtual final hexahedron that meet at the reference vertex.
